(19) United States
(12) Patent Application Publication
(10) Pub. No.: US 2009/0097902 A1
(43) Pub. Date: Apr. 16, 2009

(54) CLEANING DEVICE

(76) Inventor: Richard Lemmon, Cromwell, CT (US)

Correspondence Address: MCCORMICK, PAULDING & HUBER LLP, CITY PLACE II, 185 ASYLUM STREET, HARTFORD, CT, 06103, US

(21) Appl. No.: 11/872,889

(22) Filed: Oct. 16, 2007

(51) Int. Cl. B08B 1/00; A46B 15/00; A47L 13/00; A46B 11/00; B43M 11/02

(52) U.S. Cl. 401/140; 15/104.93; 15/105; 15/143.1; 401/219

(57) ABSTRACT

A cleaning device includes a chassis with a plurality of roller assemblies disposed therein, and a cleaning web having a first and second cleaning surface. The cleaning web extends between the roller assemblies such that the first cleaning surface of the cleaning web faces outwardly from one of the roller assemblies and towards a surface to be cleaned and the second cleaning surface faces outwardly from another roller assembly and towards the surface to be cleaned permitting both sides of the cleaning web to be used efficiently during a cleaning operation. The cleaning device further includes an advancement mechanism for advancing the cleaning web between the roller assemblies. A handle assembly with control elements is provided for guiding and controlling operation of the cleaning device. The cleaning device further includes a fluid delivery assembly for storing and delivering fluids to the cleaning web.

### FIELD OF THE INVENTION

The present invention relates, in general, to cleaning implements, and more particularly to mops.

### BACKGROUND OF THE INVENTION

Conventional mops include string mops comprising an elongate shaft having a mop head at one end of the shaft that includes a plurality of strands of liquid-absorbent material. Such mops require a wringer mechanism to remove excess liquid and debris from the mop head strands after they have been immersed in a liquid. Alternative conventional mop designs include self-wringing mops having a wringing device on the mop itself, usually positioned on the mop head. These self-wringing mops include roller sponge mops, butterfly sponge mops, flat mops, twist mops and the like.

Most conventional mops require a separate source of cleaning fluids, such as water, cleanser, liquid soap, floor wax, and the like. Typically, cleaning fluids are provided in a separate bucket. The mop head must be immersed into the bucket to rinse or re-wet the mop head (i.e., the strands or the sponge), or to apply more fluids to the mop head. The mop head is usually repeatedly dipped into the bucket having dirty fluids that are wringed and mixed in with clean fluids contained in the bucket. The repeated dipping action results in the inefficient use and application of the cleaning fluids and of the mop itself, which contacts a surface to be cleaned with dirty fluids. Further, the repeated dipping action adds time to the mopping chore and requires the user to maintain awareness of the location of the bucket to prevent spilling the bucket on already cleaned surfaces.

A similar type of cleaning device that can be used for various cleaning chores, such as mopping, dusting, and sweeping surfaces, is commercially known as a SWIFFER®, and provided by Proctor and Gamble. This device comprises an elongate shaft having a head at one end thereof for receiving replaceable fabric sheets. A user of the device can place a clean fabric sheet on the head for cleaning a floor surface. The user then cleans the floor surface by using the device in the same manner as a mop or broom. As so used, the free side of the fabric sheet contacts the floor surface and picks up dirt and debris, or otherwise cleans the floor surface by mopping or buffing. After use, or when the fabric sheet is dirty, the user can remove the fabric sheet from the head and replace it with a new, clean fabric sheet. Such cleaning devices do not efficiently utilize the surface area of the fabric sheet because, for example, only the free side of the clean sheet is ever used for a cleaning task. Moreover, with approximately 70% of one side of the fabric and 0% of the other side generally being used, only approximately 35% of the total surface area is ever used. As a result, such devices also increase the cost and time associated with cleaning a surface, since for large cleaning tasks, several fabric sheets may be needed. Additionally, the user must stop several times during the task to replace the fabric sheet with a clean sheet. Further, such devices do not provide for storage of fabric sheets, either new or used, requiring the user to either carry such replacement sheets or dirty sheets with them or interrupt a cleaning chore to go to a storage of such sheets for replacements and to discard dirty sheets.

In view of the foregoing, there is a need for a cleaning device that makes efficient use of cleaning fluids desired for a cleaning task (such as water and cleanser) and additional materials (such as cleaning fabric to apply the cleaning fluids to a floor surface). Further, there is a need for a more environmentally friendly device that does not create unnecessary waste of such cleaning fabric when used for a cleaning task. There is also a need to reduce the cost and time associated with the cleaning of a surface, which can be accomplished, in part, by a device that portably stores cleaning fluids and extra cleaning fabric with the device. Still further, there is a need to reduce the burden on the user during the handling and cleaning process often associated with moving an extra bucket, retrieving replacement fabric sheets, rinsing cleaning fluid, or discarding debris.

Accordingly, it is a general object of the present invention to provide a cleaning device design that overcomes the problems and drawbacks associated with conventional cleaning device designs as noted above.

### SUMMARY OF THE INVENTION

In accordance with a first embodiment of the present invention, an assembly for cleaning surfaces comprises a chassis having a forward end and a rear end, a forward roller assembly mounted in the chassis at the forward end, a rear roller assembly mounted in the chassis at the rear end, and an advancement mechanism for driving at least one of the forward roller assembly or the rear roller assembly. The cleaning device further includes a cleaning web having a first cleaning surface, an opposed second cleaning surface, and a leading end and a trailing end. The leading end of the cleaning web is attached to one of the forward and the rear roller assemblies and the trailing end is attached to the other of the forward and the rear roller assemblies. The cleaning web is preferably disposed between the forward and the rear roller assemblies such that at least a portion of the first cleaning surface faces outwardly from one of the forward and the rear roller assemblies and at least a portion of the second cleaning surface faces outwardly from the other of the forward and the rear roller assemblies.

According to another feature of the present invention, the cleaning web wraps around one of the forward and the rear roller assemblies to which the leading end is attached and unwraps from the other of the front and the rear roller assemblies to which the trailing end is attached. Thus, an associated advantage of the present invention is that the surface area of the cleaning web is efficiently used.

According to a further feature of the present invention, the advancement mechanism advances the cleaning web disposed between the forward and rear roller assemblies by driving at least one of the forward and rear roller assemblies. Such an advancement mechanism can employ a plurality of advancement gears for efficiently using an electric motor, for example. Furthermore, the present invention provides features for a trigger-operated or a handle-operated advancement of the advancement mechanism.

According to yet a further feature of the present invention, the cleaning device further includes a lock mechanism to restrict the advancement of the cleaning web disposed in the mop head assembly, such that efficient utilization of the cleaning web is controlled.

According to another feature of the present invention, the cleaning device further includes a handle assembly attached on the mop head assembly for maneuvering the mop head assembly along the surface. In one embodiment of the handle assembly, the assembly may comprise a generally elongate shaft for using the cleaning device in a standing position. In an alternate embodiment, the handle assembly can be a short handle for using the cleaning assembly in a kneeling position or an elevated surface. The handle assembly can include a control portion operatively communicating with the other components of the cleaning device, such as the advancement mechanism or the lock mechanism. The handle assembly can include an adjustable or fixed auxiliary handle for improved guidance, and a rotatable interface for improved performance, of the cleaning device.

A still further feature for the cleaning device of the present invention is a cleaning fluid delivery assembly that efficiently stores and variably distributes fluids to the mop head assembly. The cleaning fluid delivery system can cooperate with the components of the cleaning device, such as the advancement mechanism, to apply cleaning fluid to either or both of the surfaces of the cleaning web prior to contact with the surface to be cleaned. Various embodiments of a cleaning fluid delivery assembly can include combinations of a housing for fluid containers, pumps, valves, routing tubes, and spray mechanisms to achieve efficient distribution and/or storage of the fluids.

### BRIEF DESCRIPTION OF THE DRAWINGS

FIG. 1 is a side view of a cleaning device according to one embodiment of the present invention;

FIG. 2 is a cross sectional side view of an embodiment of a control portion of a handle assembly according to the cleaning device shown in FIG. 1;

FIG. 3 is a top exploded view of an adjustable auxiliary handle of the handle assembly according to the embodiment of FIG. 1;

FIG. 4 is a side view of an embodiment of a rotatable interface of the shaft assembly that may be used in the cleaning device shown in FIG. 1;

FIG. 5 is a top view of a chassis of a mop head assembly accommodating components of a fluid delivery assembly and of an advancement mechanism according to an embodiment of the present invention;

FIG. 6 is a front view of the chassis shown in FIG. 5;

FIG. 7 is an exploded view of a roller assembly that may be used in the chassis of FIG. 5 in accordance with the present invention;

FIG. 8 is a bottom view of the chassis shown in FIG. 5;

FIG. 9 is a side partial cross-sectional view of an advancement mechanism and a lock mechanism for use with the chassis shown in FIG. 5;

FIG. 9A is an enlarged view indicated at 9A in FIG. 9;

FIG. 10 is a side view of an advancement mechanism and a lock mechanism according to another embodiment of the present invention;

FIG. 11 is a side view of an advancement mechanism and a lock mechanism according to yet another embodiment of the present invention;

FIG. 12 is a side view of a configuration of a cleaning web disposed and extending between the front and rear roller assemblies, together with a configuration of a spray mechanism of the fluid delivery assembly in accordance with an embodiment of the present invention;

FIG. 13 is a side view of an alternative configuration of the cleaning web disposed between the front and rear roller assemblies, together with an alternative configuration of a spray mechanism in accordance with the present invention;

FIG. 14 is a top view of a reservoir assembly of the cleaning fluid delivery assembly that may be used in the cleaning device shown in FIG. 1;

FIG. 15 is a side view of the reservoir assembly shown in FIG. 14;

FIG. 16 is a front view of an embodiment of components of a the fluid flow assembly according to one embodiment of the present invention;

FIG. 17 is a top view of a manual pump for use in the fluid delivery assembly in accordance with the present invention;

FIG. 18 is a cross-sectional top view of a valve for use in the fluid delivery system in accordance with the present invention;

FIG. 19 is a cross-sectional top view of another valve for use in accordance with the present invention;

FIG. 20 is a side view of a cleaning web cutter in accordance with the present invention;

FIG. 21 is a side view of an alternate orientation or the cleaning device of FIG. 1 to clean a surface;

FIG. 22 is a side view of a another alternate orientation for the cleaning device of FIG. 1 to clean a surface.

These and other features of the present invention are described with reference to the drawings of preferred embodiments of a cleaning device and components thereof. The illustrated embodiments of the cleaning device of the present invention are intended to illustrate, but not limit, the invention.

### DETAILED DESCRIPTION OF THE INVENTION

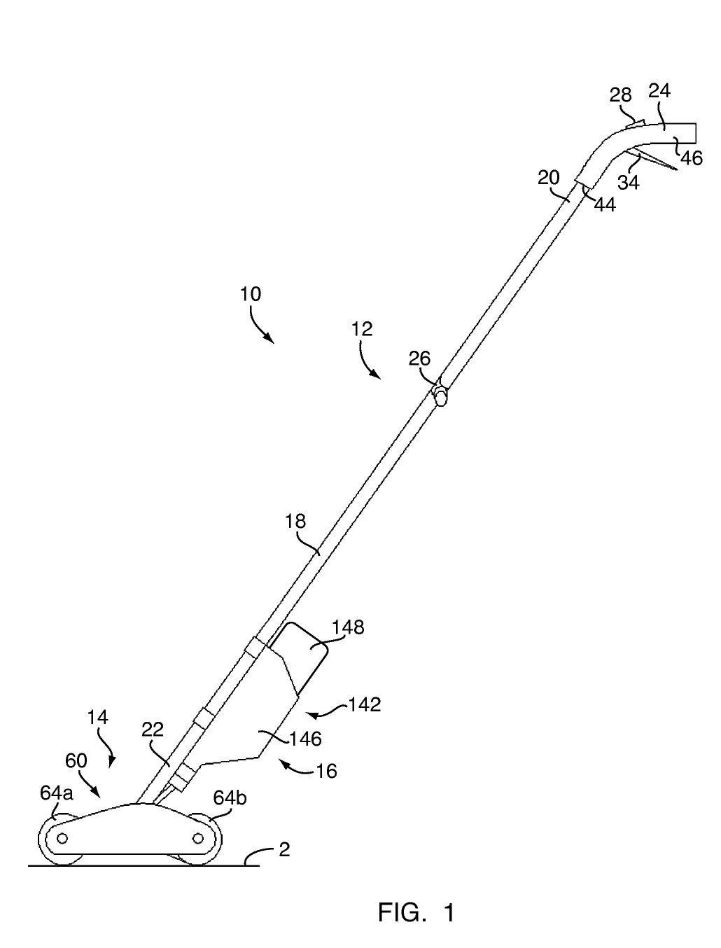

FIG. 1 generally illustrates a cleaning device 10 in accordance with a preferred embodiment of the present invention. The cleaning device 10 generally comprises a handle assembly 12, a mop head assembly 14 disposed at one end of the handle assembly 12, and a cleaning fluid delivery assembly 16 in operative communication with the mop head assembly 14 for providing cleaning fluids, such as water, cleanser, varnish, floor wax, soap, or the like, to the mop head assembly 14 to aid in use of the cleaning device to clean a surface 2. The design and components for preferred embodiments of each of these assemblies will be discussed in more detail below.

A preferred embodiment and components of the handle assembly 12 is illustrated in FIGS. 1-3. As shown, the handle assembly 12 comprises a generally elongate shaft 18 having first and second opposing ends 20 and 22, a control portion 24 disposed on the first end 20, and an auxiliary handle 26 mounted on the shaft 18 at a position intermediate the first and second ends 20 and 22. The control portion 24 preferably houses control elements for operating the mop head assembly 14, the cleaning fluid delivery assembly 16, or both. The control elements can be electrical, mechanical, or a combination thereof. The shaft 18 is preferably hollow so that control elements, such as cables and/or power lines, where used, can pass through the shaft 18 to be operatively connected to components of the mop head assembly 14 and/or the cleaning fluid delivery assembly 16.

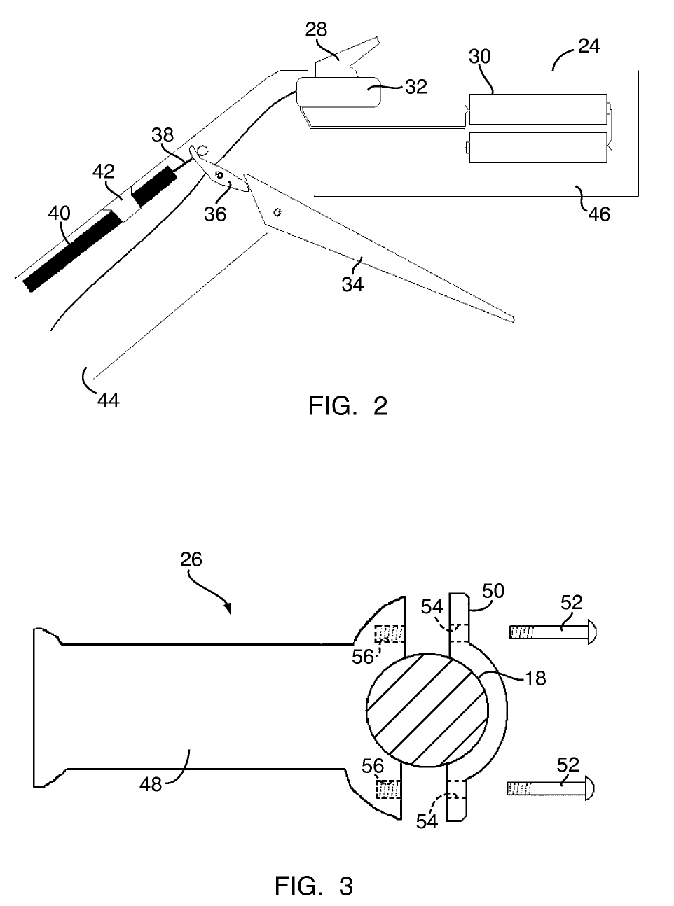

In a preferred design, the control elements include at least one electrical switch 28 in operative communication with a power source 30 and a controller 32, shown in more detail in FIG. 2, for controlling various components of the cleaning device 10, including the mop head assembly 14 and the cleaning fluid delivery assembly 16. Additional switches may be used for controlling multiple components of the cleaning device 10 where necessary or alternatively, a single switch can control multiple components of the cleaning device 10 for coordinated commands. The control elements further include a trigger mechanism 34 pivotally mounted on the control portion 24 and operatively connected to a pivot arm 36 disposed within the control portion 24 to actuate at least one lever cable 38 extending within the hollow opening of the shaft 18 in accordance with movement of the trigger mechanism 34. As with the switch 28, additional control cables may be used for controlling multiple components of the cleaning device 10, or a single cable may control multiple components of the cleaning device 10 for coordinated operation. The lever cable 38 is preferably wrapped by a sheath 40, which is secured by a cable clamp 42 disposed within the control portion 24 such that when the trigger mechanism 34 moves, the lever cable 38 actuates and the sheath 40 does not move. The sheath 40 acts to protect the lever cable 38 from damage as it moves back and forth within the handle shaft 18.

The structure of the control portion 24 is comprised of an attachment end 44 that interfaces with the shaft 18 and a grip portion 46 that, in operation of the cleaning device 10, is grasped by the user to move and guide the cleaning device 10 as desired and to operate and control certain features of the cleaning device 10, as described below. As shown, the grip portion 46 is angularly displaced from the attachment portion 44 to provide an ergonomic design to facilitate the user's operation of the cleaning device 10, though alternative designs and configurations of the control portion 24 can be used without altering the overall design and operation of the present invention.

The auxiliary handle 26 is provided on the shaft 18 to increase stability and control of the cleaning device 10 during use. That is, the user typically will grab the grip portion 46 of the control portion 24 with one hand and the auxiliary handle 26 with the other hand. As shown in FIG. 1, the auxiliary handle 26 is mounted on the shaft 18 at a position intermediate the first and second opposing ends 20 and 22 of the shaft 18. Preferably, the auxiliary handle 26 should be positioned at a level that is ergonomically comfortable to the user. To improve comfort, if desired, the auxiliary handle 26 can be designed to be adjustably positioned anywhere along the length of the shaft 18.

A preferred design of the auxiliary handle 26 is illustrated in more detail in FIG. 3. As shown, the auxiliary handle 26 includes a grip portion 48 and a clamp portion 50, which, when joined together, define an opening that generally corresponds to the outer surface of the shaft 18 and accordingly receives the shaft 18 to mount the auxiliary handle 26 thereon. The grip portion 48 and the clamp portion 50 can be joined together by any known means. As illustrated, screws 52 pass through openings 54 in the clamp portion 50 and engage complementary threaded bores 56 in the grip portion 48 of the auxiliary handle 26 to secure the respective portions together around the handle shaft 18. Tightening and loosening of the screws 52 can facilitate adjustment of the position of the auxiliary handle 26 on the shaft 18, if so desired.

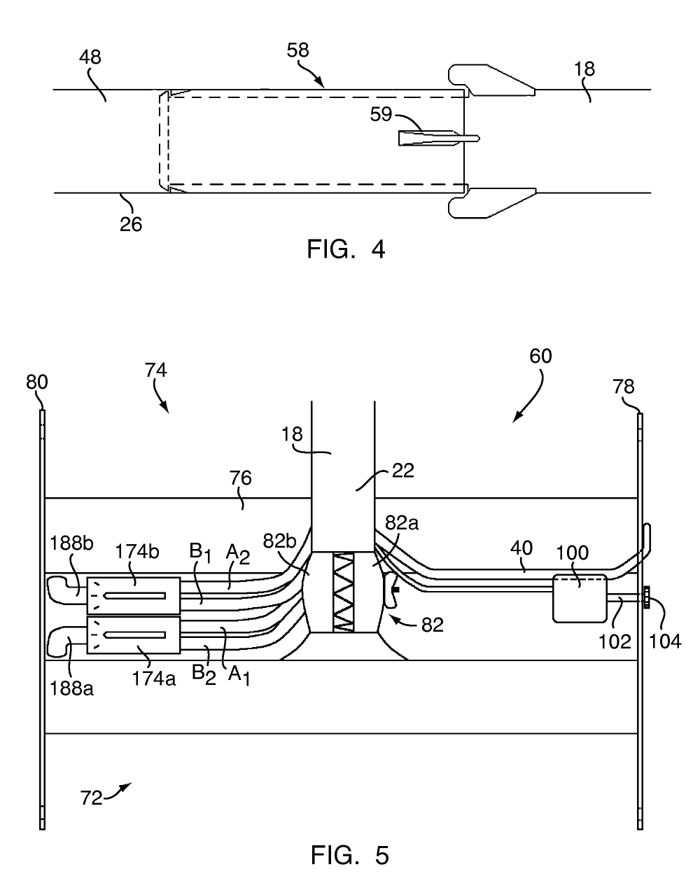

Alternatively, the auxiliary handle 26 can be permanently fixed at one position on the shaft 18. Further, the auxiliary handle 26 can house some, or all, of the control elements for the cleaning device 10, such as the electrical switch 28, power source 30 and/or the controller 32. In an alternative embodiment of the cleaning device 10, shown in FIG. 4, the shaft 18 includes a rotatable interface 58 preferably disposed between the fixed auxiliary handle 26 and the control portion 24. The rotatable interface may be employed in any manner, such as by employing portions of the shaft 18 that have varying diameters and that operatively engage. The rotatable interface includes a shaft locking mechanism that may be employed in any manner. As illustrated, the shaft locking mechanism comprises locking tabs 59 that engage and disengage corresponding recesses disposed on the shaft 18. The locking tabs 59 may be controlled electrically and, as illustrated, mechanically.

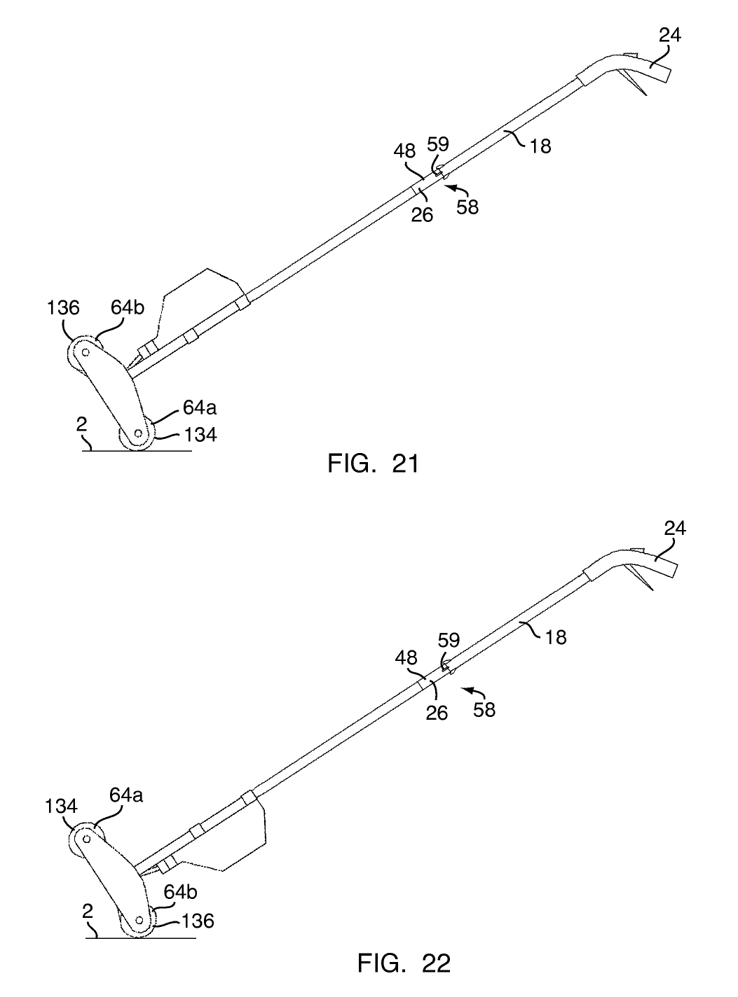

The rotatable interface 58 permits rotation of the shaft 18 about its longitudinal axis such that a user can rotate the mop head assembly 14 quickly and effortlessly during operation. As so adjusted, the relative position of the mop head assembly 14 about the shaft's axis with respect to the position of the control portion 24 can be altered. The adjustment may include 180° rotation, as seen in FIGS. 21-22. Such adjustments may be desired to move and guide the cleaning device 10 around furniture or obstructions without affecting the operation of the cleaning device 10, and without placing the user's hands, which are operating the control elements, in an undesirable, non-ergonomic position. Further, as discussed below with reference to FIGS. 21-22, the 180° adjustment may be desirable to facilitate contacting a surface being cleaned in a selective, rather than a duplicative, manner.

Though the cleaning device 10 of the present invention is illustrated with a generally elongated shaft 18, alternative embodiments of the present invention can utilize different handle assembly designs, including a design where the control portion 24 is directly mounted to the mop head assembly 14, so that the cleaning device 10 is used in a kneeling position as opposed to a standing position, as seen in FIG. 1 for example.

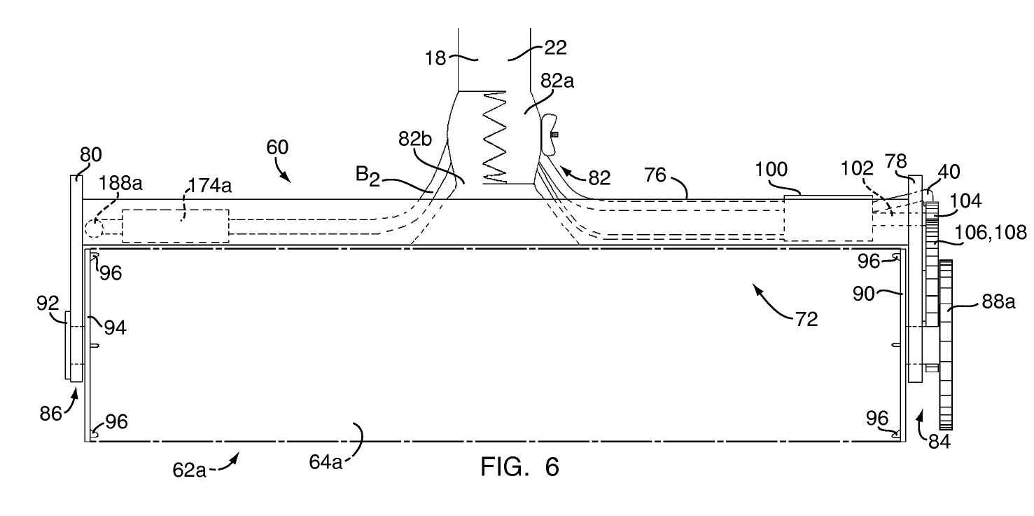

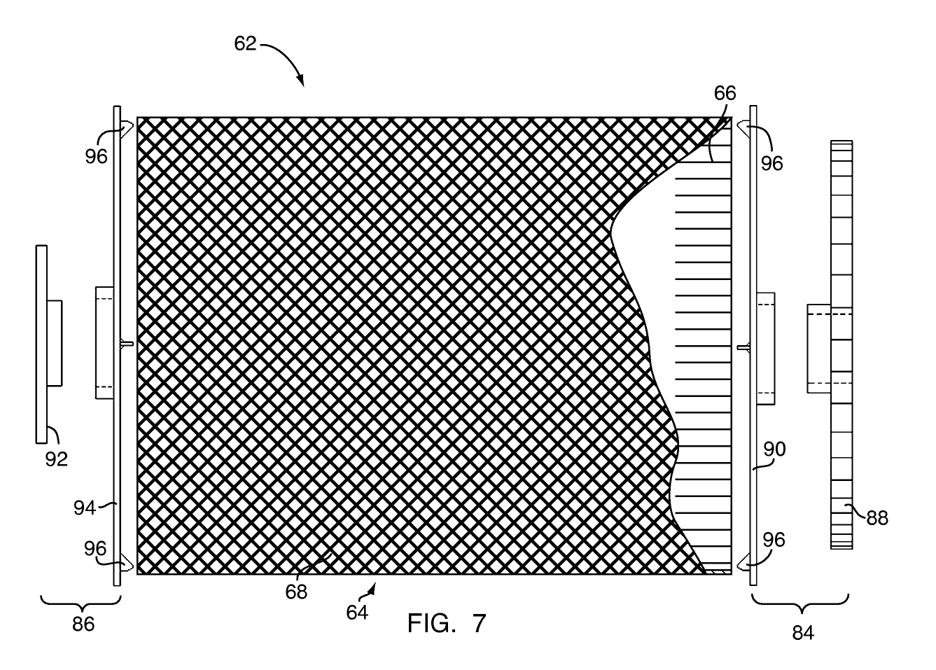

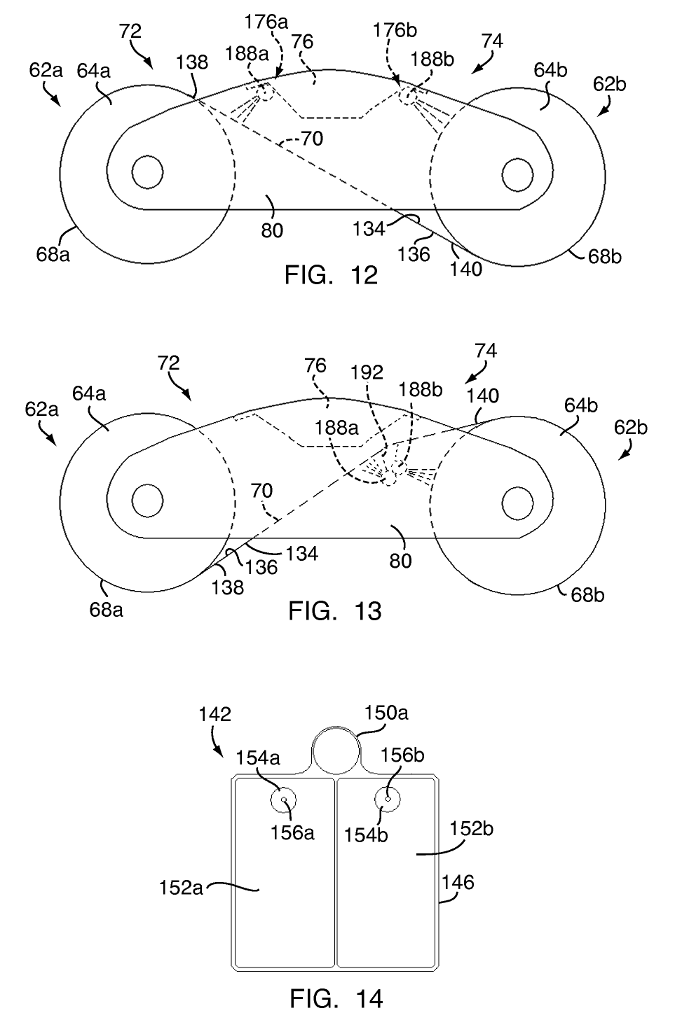

Preferred embodiments of the mop head assembly 14 are shown in FIGS. 5-13. In general, the mop head assembly 14 includes a chassis 60 accommodating a plurality of roller assemblies 62 including respective roller tubes 64 mounted therein for rotation about a longitudinal axis, as best seen in FIGS. 6-8. Each roller tube 64 preferably has grooved interior edges 66 and a slightly roughened exterior 68, as illustrated in FIG. 7. A cleaning web 70 is disposed between the roller assemblies 62, and more specifically, is adapted to be preferably wrapped around the roller tubes 64, as described in further detail below with reference to FIGS. 12-13. In a preferred design, where two roller assemblies are used, the roller assemblies 62, the roller tubes 64 and other associated components have like structure. Accordingly, discussion of the preferred components of a mop head assembly of the present invention is provided with respect to a single set of such components, which have equal applicability to a second set, or additional sets, where desired. Designation of such components in FIGS. 5-13 differentiate between sets by using alphabetical identifiers (i.e., a, b). However, the following description uses just the general numeric identifier, but is intended to describe each set accordingly.

A preferred design of the chassis 60 of the mop head assembly 14 is illustrated in FIGS. 5-8. The chassis 60 includes a forward end 72 and a rear end 74, and at least a top panel 76, a first side panel 78 and an opposing second side panel 80. As illustrated in FIG. 5, the top panel 76 can be adapted to receive operative components of the cleaning device 10, such as from the handle assembly 12 described above or from the fluid delivery assembly 16 described below. Such components can also be accommodated in an interior cavity defined by the panels 76, 78, and 80 of the chassis 60.

As illustrated, the chassis 60 is preferably pivotally attached to the second end 22 of the handle shaft 18 so that the angular relationship of the handle assembly 12 to the mop head assembly 14 can be adjusted. Such adjustment capability is beneficial during use of the cleaning device 10, such as when cleaning around or under furniture or other obstacles or in tight spaces. Attachment of the shaft 18 to the chassis 60 can be accomplished by any known means. As illustrated in FIGS. 5-6, the shaft 18 is attached to the top panel 76 of the chassis 60 using a lock joint 82 wherein the end of the shaft 18 includes a circular toothed flange 82a and the top panel 76 includes a complementary circular toothed flange 82b. The respective toothed flanges 82a, 82b are adapted to releaseably engage one another with interacting teeth, and therefore provide adjustments of the shaft 18 to a variety of angular positions with respect to the mop head assembly 14. Alternatively, the attachment end 44 of the control portion 24 may be directly attached to the top panel 76 in an embodiment of the present invention where the handle assembly does not require the generally elongate shaft 18. In such a case, as previously noted, the chassis 60 preferably is adapted to receive components of the cleaning device 10.

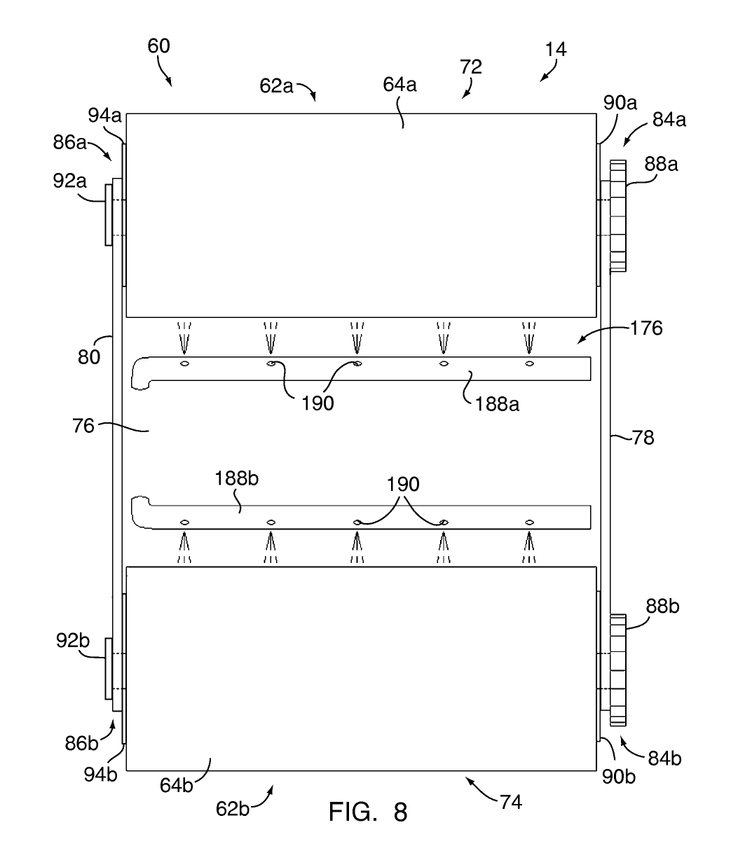

A preferred design of a roller assembly 62 used in the present invention is illustrated in FIGS. 6-8. The roller tube 64 is accommodated between a first and a second roller tube mount 84 and 86. The first roller tube mount 84 comprises a tube rotation gear 88 positioned on the exterior surface of the first side panel 78 and an end cap 90 disposed on the interior surface of the first side panel 78. The second roller tube mount 86 comprises an end plug 92 disposed on the exterior surface of the second panel 80 and an end cap 94. The tube rotation gear 88 engages the end cap 90, and the end plug 92 engages the end cap 94, such that when the first roller tube mount 84 moves, the second roller tube mount 86 moves in direct proportion when the roller tube 64 is disposed therebetween. The end caps 90, 94 each include flanges 96 that engage the grooved interior edges 66 of the roller tube 64 when the roller tube 64 is positioned between the end caps 90, 94, and therefore, allows the roller tube 64 to also move in direct proportion. The first and second side panels 78, 80 are preferably fabricated to provide a slight inward pressure on the roller tubes 64 for inhibiting their movement when the cleaning device is not in operation. In a preferred design of the mop head apparatus 14, a forward roller assembly 62a is disposed at the forward end 72 of the chassis 60, and a rear roller assembly 62b is disposed at the rear end 74 of the chassis 60, as illustrated in FIG. 8.

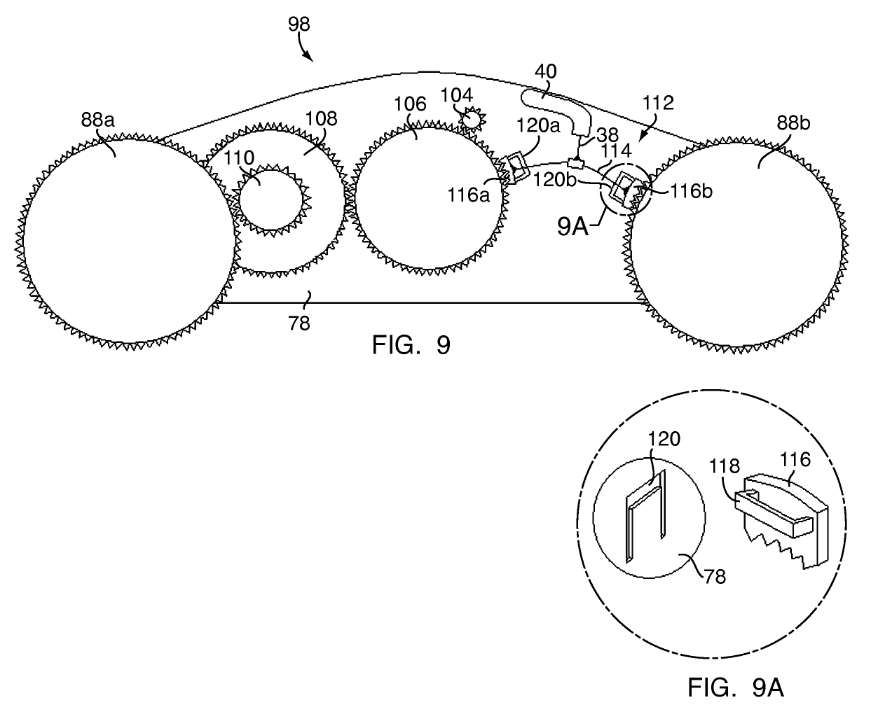

The chassis 60 is also preferably adapted to accommodate an advancement mechanism 98 for advancing at least one of the roller assemblies 62a, 62b. As illustrated in FIGS. 5-6, a roller motor 100 operatively communicates with the control portion 24 and includes a drive shaft 102 extending through an opening in the first side panel 78. The advancement mechanism 98 preferably further includes a plurality of advancement gears defined as a drive gear 104, a first transition gear 106, and a second transition gear 108, as illustrated in FIG. 9. The plurality of advancement gears are preferably mounted on the exterior surface of the first side panel 78 and are in operative communication with the roller motor 100 and the forward roller assembly 62a. The plurality of advancement gears are preferably toothed gears, as shown.

As illustrated in FIG. 9, the drive shaft 102 engages the drive gear 104, and the second transition disc 108 includes a toothed member 110 that engages the forward rotation gear 88a for the transfer of power. When power is supplied by the roller motor 100 to actuate the drive shaft 102, the drive gear 104 rotates and operatively engages the first transition gear 106. The first transition gear 106 then operatively engages the second transition gear 108 to transfer power. As the second transition gear 108 moves, the toothed member 110 operatively engages the forward rotation gear 88a. Rotation of the forward rotation gear 88a rotates the end cap 90, which, through its engagement at roller tube 64 via flanges 96 causes rotation of the roller tube 64a.

The ratio of the teeth between the drive gear 104 and the first transition gear 106, and the ratio of the teeth between the toothed member 110 and the forward rotation gear 88a is preferably such that multiple rotations of the drive gear 104 results in a fraction of a rotation of the rotation gear 84a, and thus, a fractional rotation of the forward roller assembly 62a. For example, the ratio may be ninety-six to one, for providing eight revolutions of the drive gear 104 for every one-twelfth revolution of the roller assembly 62a. The cleaning web is preferably kept between the forward roller assembly 62a and the rear roller assembly 62b so that rotation of one will impart rotation of the other.

Furthermore, the torque and rotational speed generated by the roller motor 100 can be set in view of the tooth ratios, described above, to advance the rotation gears 88 approximately thirty degrees (one-twelfth of a full rotation) per rotation of the drive gear 104. The torque that is generated overcomes the resistance generated against the first and second side panels 78, 80, but does not overcome the resistance generated by a tube lock mechanism 112. Advantageously, this arrangement provides for the use of a less powerful and less expensive roller motor 100. The ratios may be adjusted according to design goals.

As mentioned previously, the chassis 60 is also preferably adapted to accommodate the tube lock mechanism 112 for restricting the movement of the roller assemblies 62a, 62b, and of the respective roller tubes 64. In a preferred design illustrated in FIGS. 9-9A, the lever cable 38 extends through an opening in the first side panel 78 and attaches to a leaf spring 114, positioned on the exterior of the first side panel 78, having a first and second locking member 116a, 116b positioned at its ends. The leaf spring 114 biases the locking member 116b towards, and into contact with, the rear rotation gear 88b of the rear roller tube mount 84b. The leaf spring 114 also biases the locking member 116a toward, and into contact with, the first transfer disc 106, such that the first forward and rear roller tube mounts 84a, 84b are not allowed to move (i.e., the locked position). When the lever cable 38 pulls on the leaf spring 114, the locking members 116a, 116b disengage and the forward and rear roller tube mounts 84a, 84b become free to move (i.e., the free position).

As illustrated, the locking members 116a, 116b are designed to receive u-shaped bars 118 that seat into corresponding locking channels 120 on the first side panel 78. When the locking members 116a, 116b retract, they are only permitted to move in the plane created by the locking channels 120a, 120b. Locking members 116a, 116b do not dislodge from locking channels 120a, 120b because full actuation of trigger mechanism 34 does not pull the locking members 166a, 166b far enough along the locking channels 120a, 120b for bars 118a, 188b to reach the clear opening in the locking channels 120a, 120b. When the trigger mechanism 34 is released, the locking members 116a, 116b slide back into engagement with the rotation gear 88b and the first transfer disc 106. The leaf spring 114 may also be controlled electrically by control elements, such as switch 28 discussed above.

Alternatively, a trigger-operated roller tube advancement can be employed in addition to, or to supplement, the electrically-operated roller tube advancement presented above. In an embodiment illustrated in FIG. 10, the forward rotation gear 88a includes a ratchet engagement member 122 disposed thereon. The advancement mechanism 98 comprises a toothed ratchet 124 in operative communication with the trigger mechanism 34 via the cable 38. The lock assembly 112 comprises the leaf spring 114, which biases the lock members 116a, 116b downwardly and into engagement with the rotation gears 88a, 88b of the first forward and rear roller tube mounts 84a, 84b. The leaf spring 114 is designed to receive the toothed ratchet 124 in the present embodiment.

The teeth of the lock members 116a, 116b engage the teeth of the forward and rear rotation gears 88a,88b due to the biasing force of the leaf spring 114. When the trigger mechanism 34 forces the leaf spring 114 upwardly, the teeth of the lock members 116a, 116b disengage from the teeth of the rotation gears 88a, 88b, and the teeth of the toothed ratchet 124 are brought into engagement with the teeth of the ratchet engagement member 122 to advance the forward rotation gear 88a of the forward roller tube mount 84a. As previously noted, the leaf spring 114 may be controlled by electrical components, such as those described above.

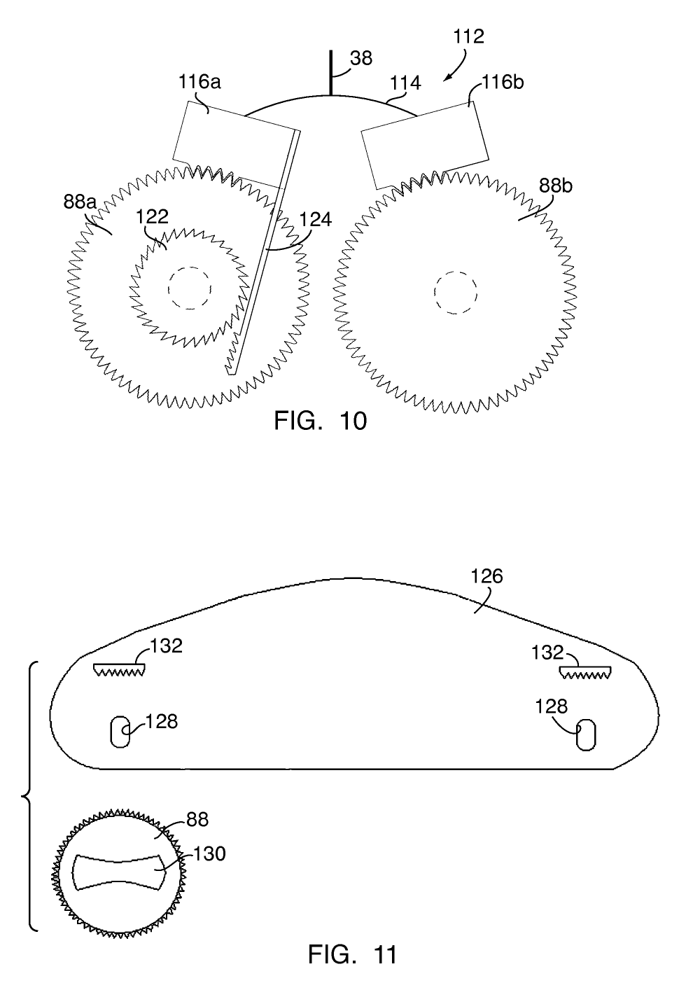

In yet another embodiment, a handle-operated roller tube advancement may be employed. In an embodiment illustrated in FIG. 11, the mop chassis 60 includes a plurality of side panels 126, each having elongate holes 128. Side panels 126 in this embodiment replace the first and second side panels 78, 80 described above. The roller assembly 62 comprises a plurality of the first roller tube mounts 84 disposed on the side panels 126 to accommodate roller tubes 64 positioned therebetween. The advancement mechanism 98 comprises a handle 130 disposed on the rotation gears 88 of the first roller tube mounts 84. The lock mechanism 112 comprises a plurality of toothed lock strips 132 disposed on the side panel 126 opposite the elongate holes 128.

The elongate holes 128 are adapted to receive the rotation gears 88, and allow the rotation gears 88 to move upwardly and downwardly within them. When the cleaning web 70 comes into contact with the surface to be cleaned, the rotation gears 88 move upwardly and into engagement with the lock strips 132 such that the cleaning web 70 is not allowed to advance. When a user lifts the mop head assembly 14, the rotation gears 88 move downwardly and disengage the lock strips 132, such that an operator can use the handle 130 disposed on either of the rotation gears 88 associated with the roller assembly receiving the cleaning web 70 to advance the fabric weave 70. Thus, the rotation gears 88 in the present embodiment preferably transmit power via the handle 130 and not with the aid of teeth disposed thereon. The rotation gears 88 may be spring biased towards the lower end of the elongated holes.

The cleaning web 70 can be disposed about the roller tubes 64 and extend between the roller assemblies 62 in any desired configuration. Preferred designs are illustrated in FIGS. 12-13, wherein the cleaning web 70 includes a first and second cleaning surface 134, 136. The cleaning web 70 further includes a leading end 138 attached to the forward roller assembly 62a as a result of being gripped by roughened exterior 68a of the forward roller tube 64a, and being wound about the forward roller tube 64a at least once. The cleaning web 70 also includes a trailing end 140 similarly attached to the rear roller assembly 64b. The cleaning web 70 extends between the forward and rear roller assemblies 64a, 64b such that at least a portion of the first cleaning surface 134 adjacent the forward roller tube 64a faces outwardly from the forward roller assembly 64a and at least a portion of the second cleaning surface 136 adjacent the forward roller tube 64a faces inwardly toward the forward roller assembly 64a. Further, at least a portion of the second cleaning surface 136 adjacent the rear roller assembly 64b faces outwardly from the rear roller assembly 64b and at least a portion of the first cleaning surface 134 adjacent the rear roller assembly 64b faces inwardly towards the rear roller assembly 64b. Thus, more than 90% of the surface area of the cleaning web is used.

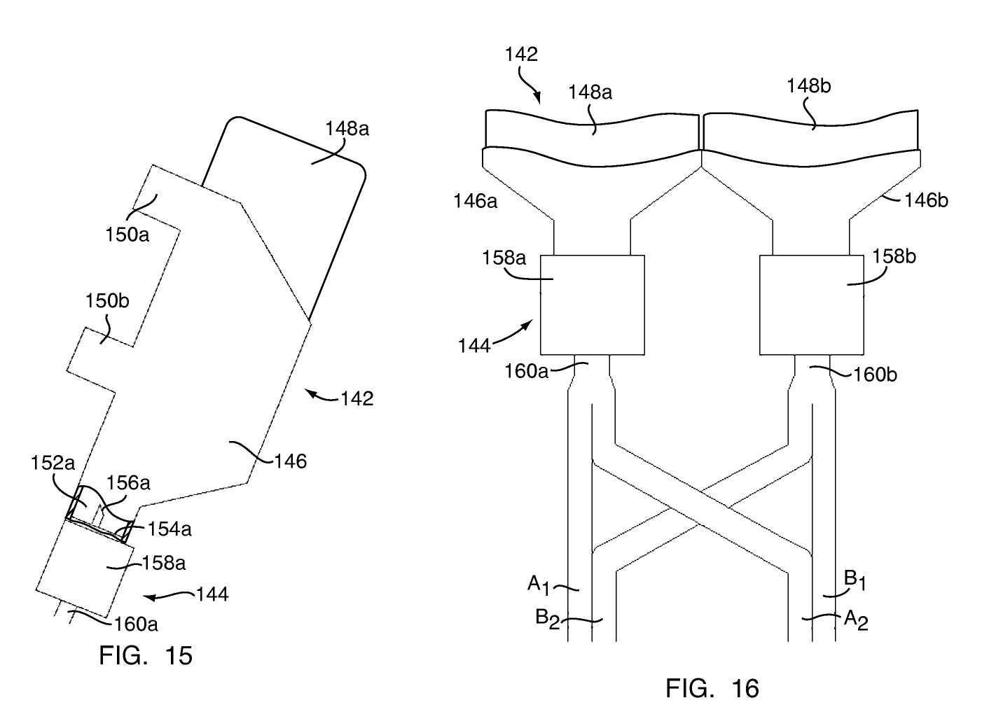

The fluid delivery assembly 16 for use with a cleaning device 10 in accordance with the present invention is illustrated in FIGS. 14-19. Generally, the delivery assembly 16 includes a reservoir assembly 142 and a flow assembly 144. The reservoir assembly 142 is preferably mounted on the handle assembly 12 at a position intermediate the first and second opposing ends 20 and 22 of the handle shaft 18. Alternatively, the reservoir assembly 142 could be mounted directly on the mop head assembly 14.

The reservoir assembly 142 is generally shown in FIGS. 14-16 and includes a reservoir housing 146 adapted to hold one or more containers 148, each of which contains a desired cleaning fluid, such as water, cleanser, varnish, floor wax, soap, or the like. The reservoir housing 146 is mounted to the shaft 18 using mounts 150 defining openings in which the handle shaft 18 is received. The reservoir housing 146 may be mounted on the handle assembly 12 using alternative means that are readily known to one of ordinary skill in the art, including traditional fasteners, such as screws, or an attachment that snap fits the housing onto the shaft 18. Further, the mounting mechanism for the reservoir housing 146 can be adapted for removal and/or replacement of the reservoir housing 146 if so desired.

As illustrated, the reservoir housing 146 is designed to accommodate two containers 148, though it can be designed to accommodate a single container, or more than two containers. For holding two containers of cleaning fluid, the reservoir housing 146 is partitioned to define two container recesses 152. In a preferred design, and as illustrated, the two containers 148, container recesses 152, and other associated components have like structure. Accordingly, discussion of the preferred components of a reservoir assembly of the present invention is provided with respect to a single set of such components, which have equal applicability to a second set, or additional sets, where desired. Designation of such components in FIGS. 14-16 differentiate between sets by using alphabetical identifiers (i.e., a, b). However, the following description uses just the general numeric identifier, but is intended to describe each set accordingly.

Each container recess 152 preferably includes a gasket 154 having a hollow needle 156. The recess 152 is designed with an open top to receive a container 148 of cleaning fluid. The gasket 154 and needle 156 are positioned at the bottom end of the recess 152. When the container 148 is inserted into the recess 152, the needle 156 perforates the fluid container 148 so that cleaning fluid contained therein can flow out through the bottom end of the reservoir housing via the hollow needle 156. The gasket 154 seals the connection between the container 148 and the reservoir housing 146 to control fluid flow out of the reservoir housing 146 and to prevent spilling and waste of cleaning fluid. As shown in FIG. 14, the needle 156 is centrally disposed on the gasket 154, and, as noted, is hollowed so that cleaning fluid flows out of the recess 152 through the hollowed center of the needle 156. The needle 156 need not be centrally disposed on the gasket 154, or even part of the gasket 154. Instead, the needle 156 could be a separate component situated in the bottom end of the recess 152 to perforate the container 148 to start fluid flow. Moreover, an opening can be provided in the gasket 154 to allow for fluid flow out of the recess 152 without the aid needles.

In an alternate embodiment of the reservoir assembly 142, the reservoir housing 146 itself operates as the container. That is, the reservoir housing 146 contains a cleaning fluid, or has an opening through which fluid can be poured into the reservoir housing 146. For delivery of cleaning fluid to the mop head assembly 14, the reservoir housing 146 is mounted to the handle assembly 12 or is accommodated by the chassis 60 with the bottom end being opened to permit fluid flow, such as by the gasket and needle design discussed above, or by otherwise creating an opening in the reservoir housing 146 through removal of a cap, seal or plug.

The flow assembly 144 of the fluid delivery assembly 16 preferably receives fluid flowing out of the reservoir assembly 142 and routes the fluid to the mop head assembly 14. Preferable components of the flow assembly 144 are illustrated in FIGS. 8 and 16-19. As illustrated, the flow assembly includes a pump 158 adapted to sealingly interface with the reservoir assembly 142. Where multiple containers 148 of cleaning fluid are used in the reservoir assembly 142, a separate pump 158 is preferably included for each container 148. As shown in FIG. 16, first and second pumps 158a and 158b are used. As with the above description of the reservoir assembly, the pumps 158a and 158b, and associated components have like structure. Accordingly, the description of a single generic set of components, using just the numeric identifier, applies equally to each set of components, which are illustrated in the Figures using alphabetical identifiers to distinguish each set for clarification.

Each pump 158 is connected to an outlet of an associated container recess 152 on one end. For example, where a hollow needle 156 is used, the needle 156 feeds fluid to the pump 158. The other end of the pump 158 is connected to a routing tube 160. Preferably, each pump 158 is operatively controlled by the electric switch 28, which if turned on, supplies power to the pump 158 from the power source 30. Additionally, the controller 32 in the control portion 24 of the handle assembly 12 can control operation of the pump 158 as desired. Though the power source 30 and the controller 32 are shown in the handle assembly 12, an alternative design of the present invention can supply a power source and a controller for each pump 158 with the pump 158 itself, as either a primary or backup control mechanism. Further, for an embodiment such as that shown in FIG. 16, where first and second pumps 158a, 158b are used in the fluid delivery assembly 16, a separate switch can be used to control operation of each pump 158a or 158b, or alternatively, a single switch can be used to control the coordinated operation of both pumps 158a and 158b.

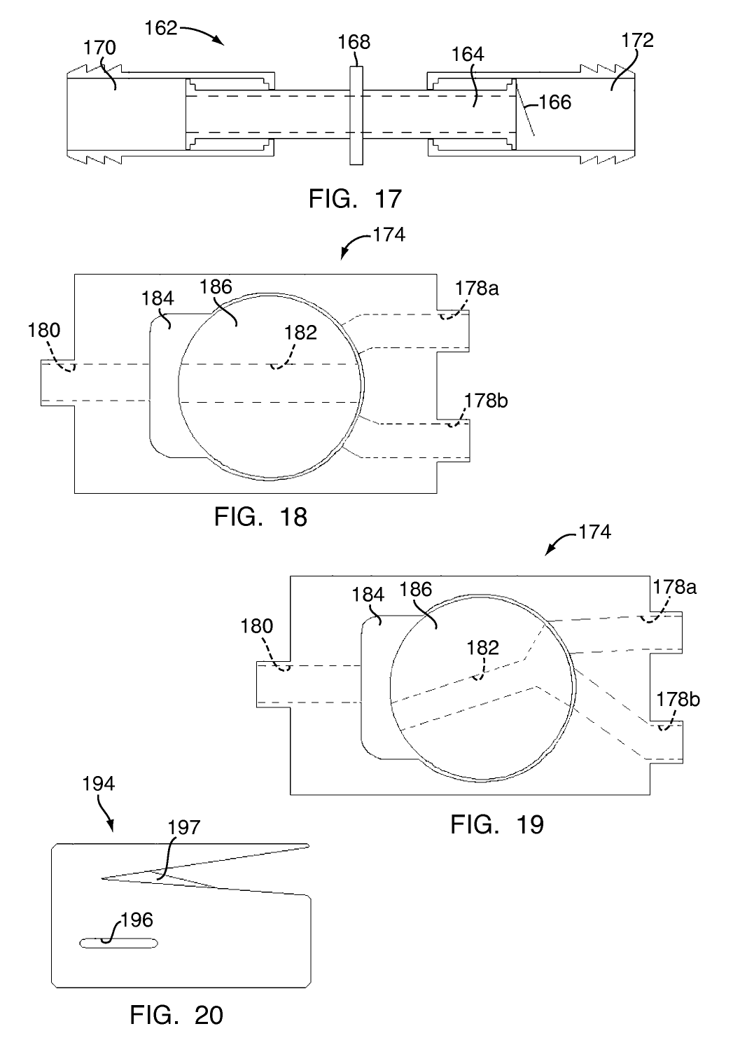

Though a preferred embodiment of the present invention uses electric pumps, an alternate design may use manual pumps. Such an alternative design is shown in FIG. 17. A manual pump, generally designated as reference numeral 162, includes an interiorly disposed pump channel 164 and a check valve 166 for providing unidirectional flow between the reservoir assembly 142 and the mop head assembly 14. A plunger 168 communicates with the pump channel 164 to apply a vacuum to the container 148 held by the reservoir assembly 142 when a user actuates the plunger 168. Pump action may be generated by actuation and release of a trigger mechanism on the handle (such as trigger mechanism 34 shown in FIG. 2). Operating the trigger mechanism 34 can be translated into oscillation of the plunger 168, causing fluid to be pulled through an intake port 170 and pushed to an output port 172. The plunger 168 may be spring-biased to a resting position after the trigger action has actuated the plunger 168 away from the resting position. Additional manual pump designs known to persons of ordinary skill may be accommodated by the present invention to draw cleaning fluid from the reservoir assembly and deliver the fluid to the mop head assembly.

The flow assembly 144 of the present invention preferably also includes at least one valve 174 for selective distribution of fluid, such as from the containers 148, and a spray mechanism 176 for applying the cleaning fluid to the cleaning web 70, which are described in greater detail below. Referring back to FIG. 16, each routing tube 160 extending from an associated pump 158 provides a flow pathway for the associated cleaning fluid from one of the containers 148 to the mop head assembly 14. Where multiple containers 148 are used, each routing tube 160 is preferably divided into sub-tubes so that fluid streams from each container can be initially routed to, and available at, multiple locations for individual distribution or for mixing prior to distribution.

A preferred design for routing cleaning fluids from two containers is shown in FIG. 16. Thus, for example, a first container (148a in FIG. 16) can include water while a second container (148b in FIG. 17) includes a cleanser. The water from container 148a flows through routing tube 160a, which divides into sub-tubes A₁ and A₂. The cleanser from container 148b flows through routing tube 160b, which divides into sub-tubes B₁ and B₂. The sub-tube A₁ converges and travels with the sub-tube B₂ at a valve 174a. Similarly, the sub-tube A₂ converges and travels with the sub-tube B₁ at a second valve 174b.

Valve designs that may be used in the flow assembly 144 are illustrated in FIGS. 18-19. The valve 174 is adapted to receive cleaning fluid from the routing tubes 160 and any divisions thereof into sub-tubes, and direct fluids to the spray mechanism 176 disposed in the mop head assembly 14. Additionally, the valve 174 provides the user with a control for selectively routing cleaning fluids from multiple containers, such as shown in FIG. 16. The valves 178 are reversible. In a preferred design, the valve 174 includes at least one input valve channel 178 in communication with the reservoir assembly 142, at least one output valve channel 180 in communication with the spray mechanism 176, and a central valve channel 182 disposed therebetween. The valve 174 further includes a valve reservoir 184, disposed between the central valve channel 182 and the output valve channel 180, as illustrated, or the input valve channel 178, for collecting fluid passing therebetween. Further, the valve 174 includes a valve control 186, which may be mechanical or electrical, in operative communication with the central valve channel 182, such that a user can selectively regulate flow of cleaning fluid through the valve 174.

In one embodiment of the valve 174, illustrated in FIG. 18, there are two input valve channels 178a and 178b. Input valve channel 178a communicates with routing tube(s) associated with a first fluid container 148a. Input valve channel 178b communicates with routing tube(s) associated with a second fluid container 148b. The valve 174 may restrict flow of fluids by being positioned as shown in FIG. 18. As shown, the central valve channel 182 is not in alignment with either input valve channel 178a, 178b, and fluid flow is accordingly blocked.

When a user wants to commence fluid flow, the central valve channel 182 can be selectively aligned with either of the input valve channels 178a or 178b. Thus, the valve control can be aligned with input valve channel 178a to allow a first cleaning fluid (e.g., water) to pass through the central valve channel 182, the valve reservoir 184 and out through the output channel 180, and then shift the valve control 186 to align the central valve channel 182 with the input valve channel 178b to allow a second cleaning fluid (e.g., cleanser) to follow the same path once the user has waited until the reservoir 184 clears.

Alignment of the central valve channel 182 can be controlled by the valve control 186 which can be in operative communication with additional control elements located in the control portion 24 of the handle assembly 12, or located in the cleaning fluid delivery assembly 16. When the central valve channel 182 is aligned with the input valve channel 178, cleaning fluid routed through the associated routing tube(s) 160 is directed through the valve 174 to the output valve channel 180 and ultimately to the spray mechanism 176 disposed in the mop head assembly 14.

In an alternative embodiment of the valve 174 illustrated in FIG. 19, the central valve channel 182 may be designed so that a user can simultaneously align the central valve channel 182 with both input valve channels 178, and thus feed cleaning fluid (e.g., water and cleanser) streaming from both routing tubes 160 through the valve 174 at the same time, thereby mixing the streams during the distribution process. When the user wants to stop fluid flow, the valve control 186 can be used to take the central valve channel 182 out of alignment with the input valve channels 178, thereby restricting fluid flow through the valve 174. The valves 174 may sealingly interface with any other component of the cleaning device 10, including the components of the reservoir assembly 142.

As previously mentioned, the valve 174 is reversible. Thus, taking FIG. 19 as an example, the valve 174 can also be employed with the single-channel side operating as the input and the dual-channel side operating as the output relative to the fluid flow. When the cleaning device 10 includes but one reservoir and one pump, for example, this configuration can operate to ultimately distribute one fluid to both roller assemblies 62a, 62b. Similarly, the valve 174 illustrates in FIG. 18 can ultimately operate to ultimately distribute one fluid to either roller assemblies 62a, 62b.

The spray mechanism 176 includes a spray channel 188 in communication with the valve 174 for providing a path for the fluid to the cleaning web 70. A preferred embodiment of the spray mechanism 176 is illustrated in FIGS. 5 and 8, wherein a first and second spray channel 188a, 188b are positioned to face one of the forward and the rear roller assemblies 62a, 62b. The spray channels 188a, 188b include apertures 190 which are spaced so as to provide even distribution to the first or the second cleaning surface 134, 136 of the cleaning web 70. Referring back to FIG. 12, the cleaning fluid is applied to the first clean surface 134 of the cleaning web 70 by the spray channel 188a, and is applied to the second cleaning surface 136 of the cleaning web 70 by the spray channel 188b.

In an alternative preferred design illustrated in FIG. 13, the spray channels 188a, 188b are positioned within the mop head assembly 14 on a spray tube trestle 192 extending beneath the top panel 76 and between the side panels (either the first and the second 78, 80, or the plurality of the side panels 126). The spray channels 188a, 188b are each positioned below the cleaning web 70, which is routed over the top of the trestle 192 such that the fluid from the spray channels 188a, 188b is applied to the first and the second cleaning surfaces 134, 136 of the cleaning web 70 from one location.

The cleaning device 10 may further include other components, in addition to those presented above, that operate to reduce the burden on the user. As illustrated in FIG. 20, a cutter 194 includes a recess 196 disposed in the center of the cutter 194 for positioning the cutter on the mop head assembly 14. A user may pass the cleaning web 70 past a cutting edge 197 to cut the cleaning web 70 and remove, for example, the forward roller tube 64a having the contacted cleaning web 70 disposed thereon (i.e., the portion of the cleaning web that has been in contact with the surface 2 cleaned). The user may then remove the contacted cleaning web 70 from the forward roller tube 64a and draw the leading end 138 of the cleaning web 70, disposed on the rear roller tube 64b, to the empty forward roller tube 64a in any configuration desired. Advantageously, the roller tubes 64 may be used repeatedly.

In operation of the cleaning device 10 of the present invention to clean a surface 2, the user first positions the roller tube 64b, which includes the cleaning web 70 disposed thereon, between the first and second roller tube mounts 84b, 86b of the rear roller assembly 62b. The user then extends the cleaning web 70 from the rear roller tube 64b to the forward roller tube 64a positioned between the mounts 84a, 86a, and secures the leading end 138 of the cleaning web 70 to the forward roller tube 64a. Such a configuration is illustrated, for example, in FIG. 12. The cleaning web 70 should preferably be wrapped around the first roller tube 64a so that a portion of the first cleaning surface 134 faces outwardly, and then wraps around, the first roller tube 64a, and such that the second cleaning side 136 faces outwardly relative to the second roller tube 64b. That way, both cleaning sides 134, 136 of the cleaning web 70 can be efficiently used to clean a surface.

The user then adjusts the angular position of the shaft 18 with respect to the mop head assembly 14 to the desired position by adjusting the flanges 82a, 82b of the locking joint 82. Next, the user inserts the containers 148a, 148b into the container recess 152 such that the needles 156 perforate the containers 148. The user sets the valves 174 as desired by, for example, manually operating the valve controls 186. One such setting may allow the cleaning fluid that will pass through the sub-channels A₁ and A₂ to be respectively mixed with B₁ and B₂ and simultaneously applied to the first and the second clean surface 134, 136 of the cleaning web 70, as illustrated by the valve of FIG. 19.

The user then grips the grip portion 46 of the control portion 24 with one hand and the grip portion 48 of the auxiliary handle 26 with the other hand, for added stability. The user operates the switch 28 disposed on the control portion 24 of the handle assembly 12 to start the electric pumps 158a, 158b, which begin to pump fluid from the containers 148a, 148b. Next, the user actuates the lever mechanism 34 to move the lever cable 38, which results in the lock mechanism 112 being brought to the free position. Once the rear rotation gear 88b and the first transfer gear 106 are free to move, the user operates the switch 28 to start the roller motor 100. Motion is then transferred from the drive gear 104 to the forward rotation gear 88a, and the forward roller tube 64a begins to rotate, winding the cleaning web 70 about the forward roller tube 64a. The rear roller tube 64b also rotates as the leading end 138 of the cleaning web 70 is wound about the forward roller tube 64a, and unwound from the rear roller tube 64b.

Pumped fluid passes through the valves 174 and into the spray channels 188a, 188b of the spray mechanism 176. The fluid is then dispersed to both the first and second clean sides 134, 136 of the fabric web 70 through the spray apertures 190. Once the desired amount of cleanser is applied, the user deactivates the electric pumps 158a, 158b and sets lock mechanism 112 to the locked position via the trigger mechanism 34. The valves 174 are preferably maintained in their current states, although they can be adjusted accordingly by, for example, aligning the central channel 182 to any desired position using the control 186. The user then contacts the surface to be cleaned with the cleaning web 70 wound about the forward and rear roller tubes 64a, 64b.

Once the user is satisfied with the contact of the cleaning web 70, the operation described above can be repeated accordingly to advance the cleaning web 70 for clean fabric and reapply cleaning fluids as necessary. For instance, if there is fluid remaining after the prior application, the user repeats the process from the step of operating the switch 28 to activate the pump motors 158a, 158b and continues through the process to the step of contacting the surface with the cleaning web 70. This repetition results in advancing the cleaning web 70 from the rear roller tube 64b to the forward roller tube 64a, such that there is a precise dosage of cleanser used, and such that the first and second cleaning surfaces 134, 136 contact the surface being treated. Moreover, this repetition results in advancing the contacted portion of the cleaning web 70 into the mop head assembly 14. Thus, the user advantageously does not have to waste time during the cleaning process or is burdened to remove the portion of the cleaning web 70 that has contacted the surface cleaned after each administration. Further, the user may advantageously store the cleaning device 10 with both the contacted and un-contacted portions of the cleaning web 70 until it is entirely used.

The operation of the present embodiment invention changes according to the features employed that are described herein, or their equivalents, although the benefits of the present invention remain. As previously stated, the activation and deactivation, as discussed above, may be accomplished, coordinated, or otherwise employed by a single switch 28, such that, for example, a user can unlock, spray, and advance the cleaning web all at once. As a further example, when the manual pump 162 is used, a user operates the plunger 168 to pump fluid from the reservoir assembly 142 to the mop head assembly 14.

When the trigger-operated roller tube advancement is employed, as illustrated in FIG. 10, the user can operate the trigger mechanism 34 to actuate the lever cable 38, such that the locking members 116a, 116b disengage and such that the toothed ratchet 124 engages the ratchet engagement member 122 disposed on the forward rotation gear 88a. Such an operation is repeated to advance the cleaning web 70 between the roller assemblies 62.

Alternatively, when the handle-operated roller tube advancement is employed, as illustrated in FIG. 11, the user can lift the mop head assembly 14, thereby allowing the plurality of rotation gears 88 to disengage from the plurality of lock strips 132 when the rotation gears 88 slide downwardly within the elongate holes 128. The user may then rotate the roller tubes 88 having the cleaning web 70 disposed thereon by using the handles 130 disposed on the corresponding rotation gear 88. To engage the rotation gears 88 with the lock strips 132, the user may merely set the mop head assembly 14 on the surface to be treated.

In an alternative operation, where cleaning device 10 includes the auxiliary handle 26 that is fixed on the shaft 18 which includes the rotatable interface 58, the operation further includes adjusting the angular position of the shaft 18 such that the shaft 18 is substantially perpendicular to the mop head assembly 14, as seen in FIGS. 21 and 22. As illustrated in FIG. 21, the user places the cleaning web 70 disposed about the forward roller tube 64a into contact with the surface, and then, as seen in FIG. 22, disengages the locking tabs 59, rotates the shaft 18 approximately 180°, engages the locking tabs 59, and places the cleaning web 70 disposed about the rear roller 64b into contact with the surface. Thus, the user employs the cleaning web 70 selectively, rather than using the cleaning web 70 in a duplicative manner. Instead of having two contact points, a user can contact the second clean surface 136 of the cleaning web 70 with the surface being cleaned and then contact first clean surface 134 of the cleaning web 70 with a different portion of the surface to be cleaned. The user accomplishes this operation quickly and with minimal effort and maximum control over the cleaning device 10 with the aid of the auxiliary handle 26 and the rotatable interface 58. Rotation of the shaft 18 ensures that the control portion 24 of the handle assembly 12 remains in an ergonomic and stable position regardless of which roller tube 64 contacts the surface 2.

The foregoing description of embodiments of the invention has been presented for the purpose of illustration and description, and is not intended to be exhaustive of the limit the invention in the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as intended to the particular uses contemplated. It is intended that the scope of the invention be defined by the claims appended hereto.

What is claimed is:

1. An assembly for cleaning surfaces comprising:
a chassis having a forward end and a rear end;
a forward roller assembly mounted in the chassis at the forward end;
a rear roller assembly mounted in the chassis at the rear end;
a flexible cleaning web having a first cleaning surface, an opposed second cleaning surface, a leading end and a trailing end;
wherein the leading end of the cleaning web is attached to one of the forward and the rear roller assemblies and the trailing end of the cleaning web is attached to the other of the forward and the rear roller assemblies;
an advancement mechanism for driving at least the roller assembly to which the leading end of the cleaning web is attached;
whereby operation of said advancement mechanism transfers the cleaning web between the forward roller assembly and the rear roller assembly by wrapping the cleaning web around the one of the forward and the rear roller assemblies to which the leading end of the cleaning web is attached and simultaneously unwrapping the cleaning web from the other of the front and the rear roller assemblies to which the trailing end of the cleaning web is attached;
whereby the cleaning web is adapted to be wrapped around the one of the forward and the rear roller assemblies to which the leading end of the cleaning web is attached so that the first cleaning surface faces outwardly from and the second cleaning surface faces inwardly toward said roller assembly; and
further whereby the cleaning web is adapted to be wrapped around the other of the forward and the rear roller assemblies to which the trailing end of the cleaning web is attached so that the first cleaning surface faces inwardly toward and the second cleaning surface faces outwardly from said roller assembly.

2. The assembly according to claim 1, wherein the advancement mechanism comprises a roller motor and a plurality of advancement gears in operative communication with the roller motor and at least one of the forward and the rear roller assemblies.

3. The assembly according to claim 1, wherein the advancement mechanism comprises a toothed ratchet in operative communication with at least one of the forward and the rear roller assemblies.

4. The assembly according to claim 1, wherein the advancement mechanism comprises a handle in operative communication with at least one of the forward and the rear roller assemblies.

5. The assembly according to claim 1, further comprising lock mechanism for restricting the movement of the at least one of the forward and the rear roller assemblies driven by the advancement mechanism.

6. The assembly according the claim 1, further comprising a cleaning fluid delivery assembly for storing and distributing cleaning fluids, said cleaning fluid delivery assembly comprising:
a reservoir assembly including a reservoir housing defining at least one recess for holding a cleaning fluid; and
a flow assembly comprising:
a spray mechanism for distributing cleaning fluid to the cleaning web;
a routing tube for delivering fluid from the reservoir housing to the spray mechanism;
a pump for drawing fluid from the reservoir housing and directing said fluid towards the spray mechanism; and
a valve for regulating the flow of the cleaning fluid between the reservoir housing and the spray mechanism.

7. The assembly according to claim 6, wherein the valve receives multiple cleaning fluid streams at one of its ends and sequentially delivers the cleaning fluid streams to the spray mechanism.

8. The assembly according to claim 1, further comprising a handle assembly attached to the chassis for maneuvering the assembly to clean surfaces.

9. The assembly according to claim 8, wherein the handle assembly includes a control mechanism for operating at least the advancement mechanism.

10. A cleaning device for cleaning surfaces comprising: a chassis having a forward end and a rear end;
a forward roller assembly mounted in the chassis at the forward end;
a rear roller assembly mounted in the chassis at the rear end;
a flexible cleaning web having a first cleaning surface, an opposed second cleaning surface, a leading end and a trailing end;
wherein the leading end of the cleaning web is attached to one of the forward and the rear roller assemblies and the trailing end of the cleaning web is attached to the other of the forward and the rear roller assemblies;
an advancement mechanism for driving at least the roller assembly to which the leading end of the cleaning web is attached;
whereby operation of said advancement mechanism transfers the cleaning web between the forward roller assembly and the rear roller assembly by wrapping the cleaning web around the one of the forward and the rear roller assemblies to which the leading end of the cleaning web is attached and simultaneously unwrapping the cleaning web from the other of the front and the rear roller assemblies to which the trailing end of the cleaning web is attached;
whereby the cleaning web is adapted to be wrapped around the one of the forward and the rear roller assemblies to which the leading end of the cleaning web is attached so that the first cleaning surface faces outwardly from and the second cleaning surface faces inwardly toward said roller assembly;
further whereby the cleaning web is adapted to be wrapped around the other of the forward and the rear roller assemblies to which the trailing end of the cleaning web is attached so that the first cleaning surface faces inwardly toward and the second cleaning surface faces outwardly from said roller assembly; and
a handle assembly comprising: a generally elongated shaft having a first end and a second end, the first end of the shaft being attached to the chassis; and a grip portion disposed on the second end of the shaft.

11. The cleaning device according claim 10, further comprising a rotatable interface for adjusting the relative rotational position of the grip portion with respect to the chassis.

12. The cleaning device according to claim 10, wherein the grip portion includes a control mechanism in operative communication with the advancement mechanism.

13. The cleaning device according to claim 10, further comprising a cleaning fluid delivery assembly for storing and distributing cleaning fluids, said cleaning fluid delivery assembly comprising:
a reservoir assembly including a reservoir housing defining at least one recess for holding a cleaning fluid; and
a flow assembly comprising:
a spray mechanism for distributing cleaning fluid to the cleaning web;
a routing tube for delivering fluid from the reservoir housing to the spray mechanism;
a pump for drawing fluid from the reservoir housing and directing said fluid towards the spray mechanism; and
a valve for regulating the flow of the cleaning fluid between the reservoir housing and the spray mechanism;
wherein the grip portion of the handle assembly includes a control mechanism in operative communication with at least one of the pump and the valve.

14. The cleaning device according to claim 10, further comprising an auxiliary handle adjustably mounted on the shaft at a position intermediate the first and second ends thereof.

15. A cleaning device for cleaning surfaces comprising:
a chassis having a forward end and a rear end;
a forward roller assembly mounted in the chassis at the forward end;
a rear roller assembly mounted in the chassis at the rear end;
a flexible cleaning web having a first cleaning surface, an opposed second cleaning surface, a leading end and a trailing end;
wherein the leading end of the cleaning web is attached to one of the forward and the rear roller assemblies and the trailing end of the cleaning web is attached to the other of the forward and the rear roller assemblies;
an advancement mechanism for driving at least the roller assembly to which the leading end of the cleaning web is attached;
whereby operation of said advancement mechanism transfers the cleaning web between the forward roller assembly and the rear roller assembly by wrapping the cleaning web around the one of the forward and the rear roller assemblies to which the leading end of the cleaning web is attached and simultaneously unwrapping the cleaning web from the other of the front and the rear roller assemblies to which the trailing end of the cleaning web is attached;
whereby the cleaning web is adapted to be wrapped around the one of the forward and the rear roller assemblies to which the leading end of the cleaning web is attached so that the first cleaning surface faces outwardly from and the second cleaning surface faces inwardly toward said roller assembly;
further whereby the cleaning web is adapted to be wrapped around the other of the forward and the rear roller assemblies to which the trailing end of the cleaning web is attached so that the first cleaning surface faces inwardly toward and the second cleaning surface faces outwardly from said roller assembly;
a handle assembly comprising:
a generally elongated shaft having a first end and a second end, the first end of the shaft being attached to the chassis; and
a grip portion disposed on the second end of the shaft; and
a cleaning fluid delivery assembly in operative communication with the chassis for delivering cleaning fluid thereto, comprising:
a reservoir assembly including: a reservoir housing defining at least one recess for holding a cleaning fluid; and
a flow assembly comprising:
a spray mechanism for distributing cleaning fluid to the cleaning web;
a routing tube for delivering fluid from the reservoir housing to the spray mechanism;
a pump for drawing fluid from the reservoir housing and directing said fluid towards the spray mechanism; and
a valve for regulating the flow of the cleaning fluid between the reservoir housing and the spray mechanism.

16. The cleaning device according to claim 15, wherein the reservoir housing is adapted to accommodate removable containers holding the cleaning fluid within the recess.

17. The cleaning device according to claim 15, wherein the reservoir housing comprises:
a plurality of recesses, each said recess for receiving a cleaning fluid; said flow assembly comprising a pump and at least one routing tube for each said recess; and
wherein the valve provides for mixing multiple streams of cleaning fluid received from said recesses via the respective routing tubes for delivery to the spray mechanism.

18. The cleaning device according to claim 15, wherein the spray mechanism includes a first spray tube for spraying cleaning fluid on the first cleaning surface of the cleaning web adjacent to the roller assembly from which said first cleaning surface faces outwardly and a second spray tube for spraying cleaning fluid on the second cleaning surface of the cleaning web adjacent the roller assembly from which said second cleaning surface faces outwardly.

19. The cleaning device according to claim 15, wherein the routing tube is partitioned for routing fluid to multiple locations.

20. The cleaning device according to claim 15, wherein the valve is a manual valve comprising a control and a check valve for providing unidirectional fluid flow.
